(19) United States
(12) Patent Application Publication
(10) Pub. No.: US 2011/0232103 A1
(43) Pub. Date: Sep. 29, 2011

(54) Cutting tool for opening package

(75) Inventor: Barry R. Sendel, Richmond Hill (CA)

(73) Assignee: Trillium Worldwide Group Inc., Providenciales (TC)

(21) Appl. No.: 12/662,028

(22) Filed: Mar. 29, 2010

(51) Int. Cl. B26B 3/06; B26B 1/08; B26B 29/02

(52) U.S. Cl. 30/152; 30/162

(57) ABSTRACT

A cutting tool for a package or the like, comprising an elongated, generally flat and thin housing. An elongated slit extends rearwardly and generally longitudinally from the front end of the housing through a portion thereof. A cutting blade is mounted within the housing and has a cutting edge extending into the slit at an inner portion thereof. An upper front end portion of the housing on one side of the slit has an outwardly extending barb for forming an opening in a package. A lower front end portion of the housing on the opposite side of the slit is tapered inwardly toward the front end of the housing to terminate in a narrow end that can be interested into an opening in a package formed by the barb to position an adjacent portion of the package in the slit where it can be cut by the cutting blade when the housing is moved relative to the package.

### BACKGROUND OF THE INVENTION

1. Field of the Invention

The present invention relates to a cutting tool and, more particularly, a cutting tool for opening a package such as a flexible bag or the like.

2. Description of the Prior Art

Up to the present time, many different types of cutting tools have been disclosed or used for opening packages such as flexible bags or the like. Although these tools have generally served the purpose, they have been subject to one or more of the following disadvantages:

1. They have an exposed cutting blade and thus a risk of inadvertently cutting the user during the cutting operation; and/or

2. They are complicated in construction and thus difficult and expensive to manufacture; and/or

3. They are large in size and bulky, and thus difficult to handle and use; and/or

4. They are unreliable in operation; and/or

5. They cannot be removably attached to a package for convenience of storage and use when needed.

The cutting tool of the present invention is not subject to any of the above-listed disadvantages and possesses many advantages not found in previously known or used cutting tools.

### BRIEF SUMMARY OF THE INVENTION

The new and improved cutting tool of the present invention is compact, lightweight, easy and safe to use, and can be easily secured in a removable manner on a package for convenience of storage and use.

The cutting tool comprises a lightweight, compact housing of generally thin, flat, elongated or rectangular configuration having at the front end thereof an elongated, generally longitudinally extending slit that extends rearwardly through a portion of the housing and terminates in an angled portion that extends upwardly toward an upper side of the housing.

The lower portion of the housing adjacent to the slit is tapered inwardly toward the front end of the housing so as to terminate in a narrow end portion at the front end of the housing. The upper portion of the housing adjacent to the slit is provided with an outwardly extending barb or the like at the front end thereof which can be used to pierce a package such as a flexible bag to provide a small opening therein.

A narrow cutting blade is mounted in the housing and has a cutting edge that extends into the slit at the angled portion thereof for the purpose of cutting a portion of a package or the like that is inserted into the slit and moved rearwardly into engagement with the blade cutting edge at the angled portion of the slit.

In the use of the cutting tool to open a package such as a flexible bag or the like, the barb at the front end of the housing is used to pierce the package to provide a small opening therein at one side or end thereof. Thereafter, the narrow end portion of the tapered lower portion of the housing at the front end thereof is inserted into the small opening in the bag to enlarge it and to position the surrounding portion of the package in the slit. The cutting tool is then moved forwardly across the adjacent portion of the package so that the cutting blade cuts the adjacent package portion in the slit as it enters the angled portion thereof to open the package.

### BRIEF DESCRIPTION OF THE DRAWINGS

FIG. 1 is a perspective view of the cutting tool of the present invention;

FIG. 2 is a side elevational view of one side of the cutting tool;

FIG. 3 is a side elevational view of the other side of the cutting tool;

FIG. 4 is a perspective view showing the front barb of the cutting tool being inserted into a package to form an initial opening therethrough;

FIG. 5 is a perspective view showing the tapered narrow end portion of the housing being inserted into the opening formed by the front barb to position the adjacent package portion within the slit in the housing;

FIG. 6 is a perspective view showing the tapered narrow end portion of the housing being fully inserted into the opening in the package to position the adjacent package portion in engagement with the cutting blade in the housing slit for opening the bag; and

FIG. 7 is an elevational view showing the cutting tool removably mounted on a package.

### DESCRIPTION OF THE PREFERRED EMBODIMENTS

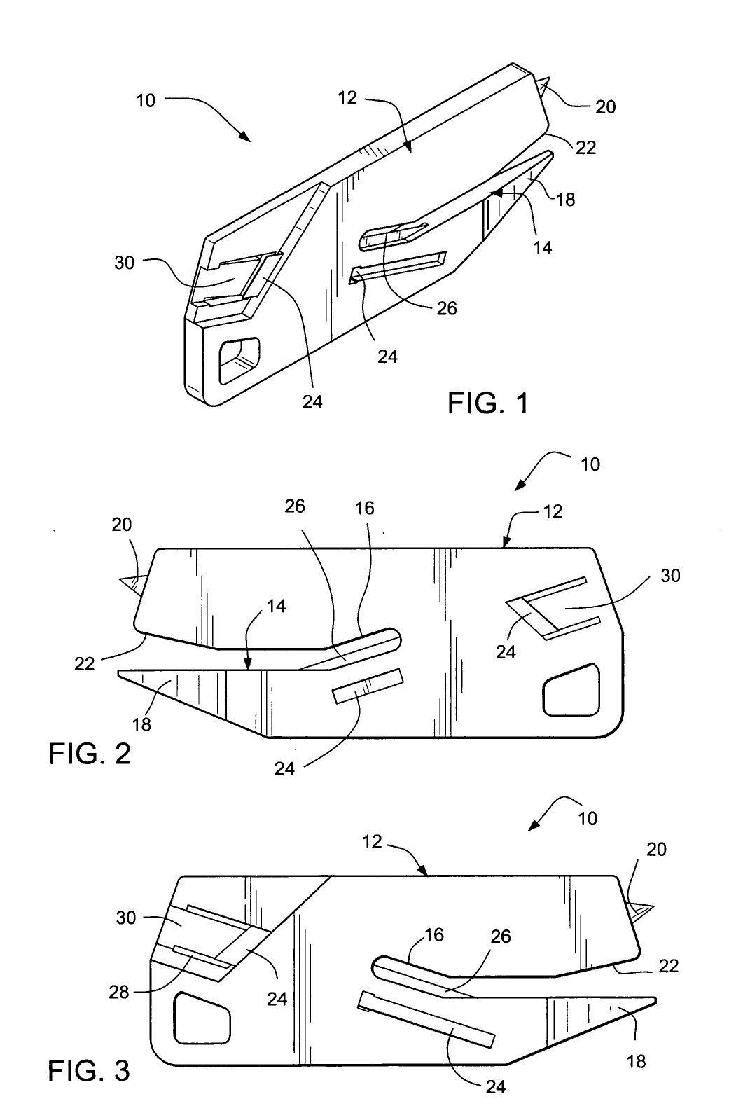

As shown in FIGS. 1-3, the cutting tool 10 of the present invention comprises a lightweight, compact housing 12 of generally flat, rectangular configuration having at the front end thereof an elongated, generally longitudinally extending slit 14 that extends rearwardly through a portion of the housing 12 and terminates in an angled portion 16 that extends upwardly toward an upper side of the housing.

The housing 12 may be formed of any suitable material and, preferably, is molded of a plastic material such as ABS plastic.

The lower portion of the housing 12 adjacent to the slit 14 is tapered inwardly toward the front end of the housing 12 so as to terminate in a narrow end portion 18 at the front end of the housing 12. The upper portion of the housing 12 adjacent to the slit 14 is provided with an outwardly extending barb 20 at the front end thereof which can be used to pierce a package to provide a small opening therein. The surface of the upper portion of the housing 12 adjacent to the slit 14 is tapered upwardly at 22 to define an enlarged slit opening at the front end of the housing 12 to facilitate the positioning of adjacent package material in the slit as more specifically described hereinafter.

A narrow cutting blade 24 is mounted in the housing 12 in any suitable manner and has a cutting edge 26 that extends into the slit 14 at the angled portion 16 thereof for the purpose of cutting the adjacent portion of a package that is positioned in the slit 14 and moved rearwardly into engagement with the edge 26 of the cutting blade 24 at the angled portion 16 of the slit 14.

The cutting blade 24 may be made of any suitable material e.g., a metal such as hardened mild steel coated with a light film of petroleum oil.

As shown in FIGS. 1-3, the cutting blade 24 may be slidably mounted in an elongated central groove 28 in the housing 12 that merges with the slit 14 at the angled portion 16 thereof so that the cutting edge 26 of the cutting blade 24 extends into the angled portion 16 of the slit 14. The cutting blade 24 is retained in the slit 28 by a flexible tab 30 formed on the housing that engages the outer end of the cutting blade 24 to retain it in the groove 28 when it is fully positioned therein as shown in FIGS. 1-3. Alternatively, the cutting blade 24 may be molded in place within the housing 12.

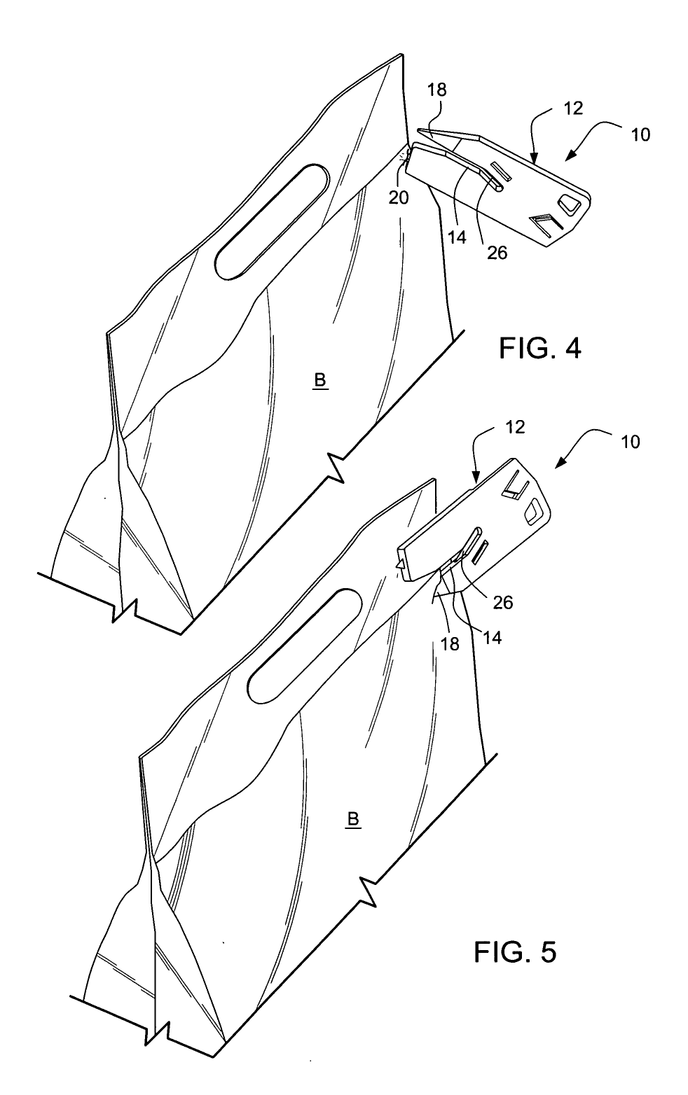

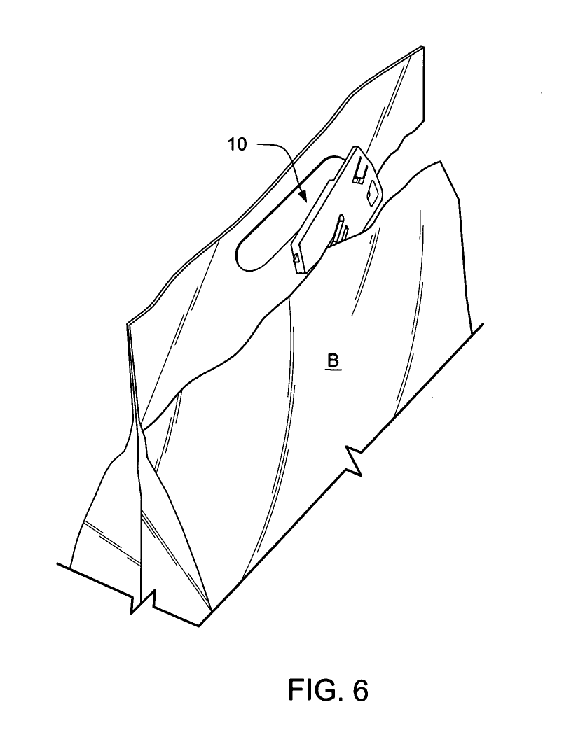

In the use of the cutting tool 10 to open a package such as a flexible bag or the like, as shown in FIGS. 4-6, the barb 20 at the front end of the housing 12 is used to pierce the package B to provide a small opening therein, at one side or end thereof, as shown in FIG. 4. Thereafter, the narrow end portion 18 of the tapered lower portion of the housing 12 at the front end thereof is inserted into the small opening in the package B to enlarge the opening and to position a surrounding portion of the package in the slit 14, as shown in FIG. 5. The cutting tool 10 is then moved forwardly across the adjacent side or end of the package B so that the cutting blade 24 cuts the adjacent package portion in the slit 14 as it enters the angled portion 16 thereof and engages the cutting edge 26 to form an elongated opening in the package B of a desired size to open the package, as shown in FIG. 6

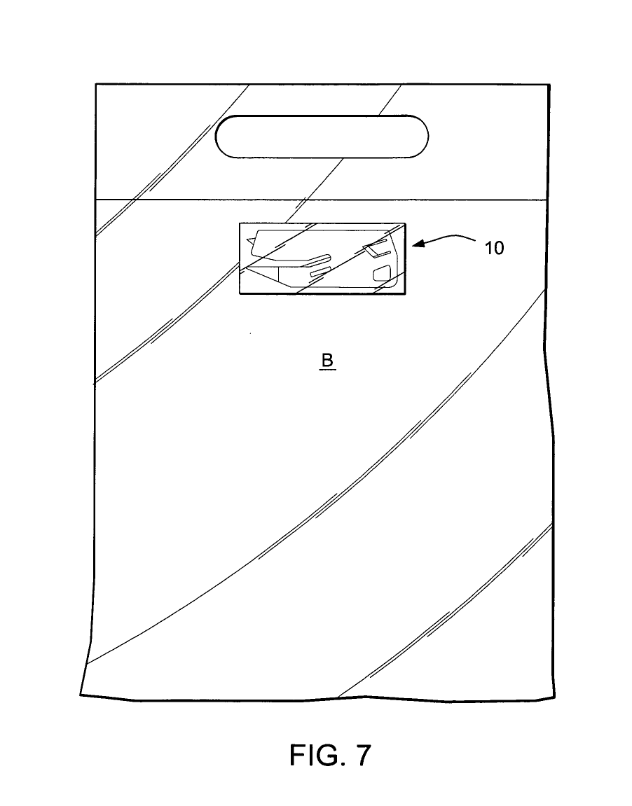

Because the cutting tool 10 of the present invention is lightweight, of elongated, narrow configuration, and simple in construction, it is easy to grip and use, and may be easily removably mounted on a package in any suitable manner with directions for its use, as shown in FIG. 7. The cutting tool 10 may be used to open packages of different materials, e.g., paper, plastic such as polyethylene or other synthetic materials without any danger of cutting the user.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A cutting tool for opening a package or the like, comprising:
an elongated, generally flat and thin housing having a front end and an upper side;
an elongated slit extending rearwardly and generally longitudinally from said front end through a portion of said housing;
a cutting blade mounted within said housing and having a cutting edge extending into said slit at an inner portion thereof spaced rearwardly from said front housing end;
an upper front end portion of said housing on one side of said slit having a barb thereon extending outwardly from said front end; and
a lower front end portion of said housing on an opposite side of said slit being tapered inwardly toward said front end to terminate in a narrow end at said front end;
whereby said barb can penetrate a package to form an opening therein, said narrow end of said tapered lower front end portion can be inserted into the opening to position an adjacent portion of the package in said slit, and said housing can be moved forwardly to move the adjacent package portion into engagement with the cutting edge of said cutting blade to cut and open the package.

2. The cutting tool of claim 1, wherein said slit terminates in an angled portion that extends upwardly toward said upper side of said housing, and said cutting edge extends into said slit at said angled portion thereof.

3. The cutting tool of claim 1, wherein said housing has an elongated central groove therein, and said cutting blade is slidably mounted within said central groove, said housing having a flexible tab in engagement with an outer end of said cutting blade to removably retain said cutting blade in said central groove.

4. The cutting tool of claim 1, wherein said housing is formed of plastic and said cutting blade is molded in position therein.

5. The cutting tool of claim 1, wherein said slit is enlarged at said housing front end to facilitate the positioning of an adjacent package portion therein for cutting and opening a package.

6. The cutting tool of claim 1, wherein said housing is formed of a lightweight plastic material.

7. The cutting tool of claim 1, wherein a portion of said housing rearwardly of said slit can be easily gripped between fingers to manipulate the cutting tool.

8. The cutting tool of claim 1 wherein said housing is generally rectangular in configuration.

9. The cutting tool of claim 1 wherein said housing is removably mounted on a package to be opened.
